(19) United States
(12) Patent Application Publication
(10) Pub. No.: US 2018/0082185 A1
(43) Pub. Date: Mar. 22, 2018

(54) PREDICTIVE MODEL UPDATING SYSTEM, PREDICTIVE MODEL UPDATING METHOD, AND PREDICTIVE MODEL UPDATING PROGRAM

(71) Applicant: NEC CORPORATION, Tokyo (JP)

(72) Inventors: Akira TANIMOTO, Tokyo (JP); Yousuke MOTOHASHI, Tokyo (JP)

(73) Assignee: NEC CORPORATION, Tokyo (JP)

(21) Appl. No.: 15/554,237

(22) PCT Filed: Mar. 23, 2015
(86) PCT No.: PCT/JP2015/001625

§ 371 Date: Aug. 29, 2017

(51) Int. Cl. G06N 5/02; G06N 7/00

(52) U.S. Cl. CPC G06N 5/02; G06N 7/005

(57) ABSTRACT

Predictive model evaluation means 81 evaluates closeness in property between a relearned predictive model and a pre-relearning predictive model. Predictive model updating means 82 updates the pre-relearning predictive model with the relearned predictive model, in the case where the closeness in property meets closeness prescribed by a predetermined condition. The predictive model evaluation means 81 evaluates closeness in prediction result or structural closeness, as the closeness in property of the predictive model.

### TECHNICAL FIELD

The present invention relates to a predictive model updating system, predictive model updating method, and predictive model updating program for updating a predictive model.

### BACKGROUND ART

Predictive models are known to degrade in prediction accuracy over time due to environmental changes and the like. Hence, a predictive model determined to improve in accuracy by updating is subjected to relearning, and updated with a predictive model generated as a result of the relearning as a new predictive model. For example, a predictive model with an increased difference between an actual value and a predicted value is selected and subjected to relearning.

Patent Literature (PTL) 1 describes an apparatus for predicting the energy demands of various facilities. The apparatus described in PTL 1 sequentially updates energy demand prediction models whenever a predetermined period has passed, using data acquired a day ago, data acquired an hour ago, or data acquired a minute ago.

### CITATION LIST

### Patent Literature

PTL 1: Japanese Patent Application Laid-Open No. 2012-194700

### SUMMARY OF INVENTION

### Technical Problem

A predictive model is typically defined based on a plurality of factors. For example, a function indicating regularity between a response variable and an explanatory variable is used as a predictive model. An administrator analyzes the degree of influence of each factor based on the prediction result by the predictive model.

It is possible to improve prediction accuracy by sequentially updating a predictive model as in the apparatus described in PTL 1. However, the factors used for prediction and the degree of influence of each factor typically vary depending on the learning data or learning method used when updating the predictive model. If the factors to be analyzed change greatly each time the predictive model is updated, the administrator needs to understand the contents of the predictive model upon each update. Considerable personnel costs (human resources) are required for such understanding.

The present invention accordingly has an object of providing a predictive model updating system, predictive model updating method, and predictive model updating program that can reduce personnel costs when updating a predictive model.

### Solution to Problem

A predictive model updating system according to the present invention includes: predictive model evaluation means which evaluates closeness in property between a relearned predictive model and a pre-relearning predictive model; and predictive model updating means which updates the pre-relearning predictive model with the relearned predictive model, in the case where the closeness in property meets closeness prescribed by a predetermined condition, wherein the predictive model evaluation means evaluates closeness in prediction result or structural closeness, as the closeness in property of the predictive model.

A predictive model updating method according to the present invention is a predictive model updating method performed by a computer, and includes: evaluating closeness in property between a relearned predictive model and a pre-relearning predictive model; and updating the pre-relearning predictive model with the relearned predictive model, in the case where the closeness in property meets closeness prescribed by a predetermined condition, wherein in the evaluation of the closeness in property, the computer evaluates closeness in prediction result or structural closeness, as the closeness in property of the predictive model.

A predictive model updating program according to the present invention causes a computer to execute: a predictive model evaluation process of evaluating closeness in property between a relearned predictive model and a pre-relearning predictive model; and a predictive model updating process of updating the pre-relearning predictive model with the relearned predictive model, in the case where the closeness in property meets closeness prescribed by a predetermined condition, wherein in the predictive model evaluation process, the computer is caused to evaluate closeness in prediction result or structural closeness, as the closeness in property of the predictive model.

### Advantageous Effects of Invention

According to the present invention, personnel costs when updating a predictive model can be reduced.

### BRIEF DESCRIPTION OF DRAWINGS

FIG. 1 is a block diagram depicting an exemplary embodiment of a predictive model updating system according to the present invention.

FIG. 2 is an explanatory diagram depicting an example of an evaluation index, a relearning rule, and an update evaluation rule.

FIG. 3 is an explanatory diagram depicting an example of visualizing a predictive model accuracy index.

FIG. 4 is an explanatory diagram depicting another example of visualizing a predictive model accuracy index.

FIG. 5 is an explanatory diagram depicting an example of visualizing predictive model similarity.

FIG. 6 is a flowchart depicting an example of the operation of the predictive model updating system.

FIG. 7 is a block diagram schematically depicting a predictive model updating system according to the present invention.

### DESCRIPTION OF EMBODIMENT

The following describes an exemplary embodiment of the present invention with reference to drawings.

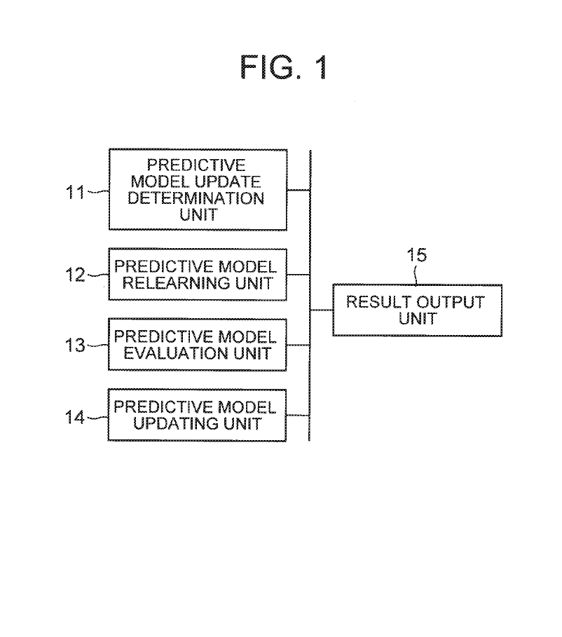

FIG. 1 is a block diagram depicting an exemplary embodiment of a predictive model updating system according to the present invention. A predictive model updating system in this exemplary embodiment extracts a predictive model of an update candidate from a plurality of predictive models, relearns the extracted predictive model, and then determines whether or not to actually update the pre-relearning predictive model with the relearned predictive model.

The predictive model updating system in this exemplary embodiment includes a predictive model update determination unit 11, a predictive model relearning unit 12, a predictive model evaluation unit 13, a predictive model updating unit 14, and a result output unit 15.

The predictive model update determination unit 11 determines a predictive model of an update candidate. In detail, the predictive model update determination unit 11 extracts a relearning target predictive model as an update candidate from a plurality of predictive models, based on a rule (hereafter referred to as “relearning rule”) for determining whether or not to relearn the predictive model. The relearning rule is a rule prescribing, based on a predetermined evaluation index, whether or not the predictive model needs to be relearned.

The evaluation index used in the relearning rule may be any index. Examples of the evaluation index include the period from the previous learning of the predictive model, the period from the previous update of the predictive model, the amount of increase of learning data, the degree of accuracy degradation over time, the change of the number of samples, and the computational resources. The evaluation index is, however, not limited to such, and any index that can be used to determine whether or not to update the predictive model may be used. The evaluation index is also not limited to data calculated from the prediction result.

By narrowing the plurality of predictive models to the relearning target by the predictive model update determination unit 11 in this way, the number of relearning target predictive models can be reduced, with it being possible to reduce relearning costs (machine resources). This is more effective in the case where there are a large number of predictive models as update candidates.

The predictive model relearning unit 12 relearns the predictive model extracted by the predictive model update determination unit 11. Any relearning method may be used. For example, the predictive model relearning unit 12 may select a data interval, and relearn the predictive model by random restart using parameters determined by a predetermined method. The predictive model relearning unit 12 may relearn the predictive model based on an algorithm defined in the relearning rule. The predictive model relearning unit 12 may generate a plurality of relearning results for one predictive model.

To reduce a change of the predictive model by relearning, the predictive model relearning unit 12 may relearn the predictive model by hot start with the pre-relearning predictive model as input. For example, in the case where the predictive model is expressed by a tree structure and a predictive formula used for prediction of input data is split into cases according to the contents of the data based on a condition assigned to each node, relearning the predictive model by hot start by the predictive model relearning unit 12 enables the generation of a predictive model approximate in tree structure or condition. Through the use of such a relearning method, the structure of the relearned predictive model approaches the pre-relearning predictive model, as a result of which personnel costs when updating the predictive model can be reduced.

The predictive model evaluation unit 13 determines whether or not to update the pre-relearning predictive model with the relearned predictive model. In detail, the predictive model evaluation unit 13 extracts an update target predictive model, based on a rule (hereafter referred to as “update evaluation rule”) for determining whether or not to actually update the predictive model with the relearned predictive model. The update evaluation rule is a rule prescribing the status of change between the predictive model before update and the predictive model after update.

The status of change prescribed by the update evaluation rule may be any status of change. In this exemplary embodiment, the predictive model evaluation unit 13 focuses on the closeness in property of the predictive model, to determine the status of change between the predictive model before update and the predictive model after update. In other words, the predictive model evaluation unit 13 evaluates the closeness in property between the relearned predictive model and the pre-relearning predictive model.

The closeness in property of the predictive model means at least the closeness in prediction result or the structural closeness of the predictive model. Thus, in this exemplary embodiment, the predictive model is kept from changing greatly by evaluating the change in property of the predictive model, in addition to improving the accuracy of the predictive model.

The following describes the method of evaluating the closeness in property of the predictive model. The method of evaluating the closeness in prediction result is described first. The closeness in prediction result means the degree of approximation between the prediction result by the predictive model before update and the prediction result by the predictive model after update.

The predictive model evaluation unit 13 can use various indexes for the prediction result. For example, the outcome of statistical processing (e.g. the sum of the squares of difference, variance calculation, etc.) on the difference between the predicted value by the predictive model before update and the predicted value by the predictive model after update may be defined as the closeness in prediction result of the predictive model. A smaller change in prediction result for the same object indicates a smaller change in predictive model.

The method of evaluating the structural closeness of the predictive model is described next. An example of the structural closeness of the predictive model is the degree of overlap in attribute (explanatory variable, factor) used in a regression formula upon prediction. In the case where the component (predictive formula) used for prediction of input data is split into cases according to the contents of the data, the degree of overlap in attribute (explanatory variable, factor) of data used for the case splitting may be defined as the structural closeness of the predictive model. The structure of the predictive model can be determined to be closer when the degree of overlap is higher.

Especially for a predictive model with high interpretiveness, the user can often recognize the influence of the attribute (explanatory variable, factor) used for prediction. For example, in the case where the material used needs to be changed if the explanatory variable used for prediction changes, the explanatory variable is preferably fixed as much as possible. In such a case, by evaluating the degree of overlap of the explanatory variable as the structural closeness of the predictive model by the predictive model evaluation unit 13, a closer predictive model can be specified for the user.

In the case where the component (predictive formula) used for prediction of input data is split into cases according to the contents of the data, the predictive model evaluation unit 13 may evaluate the structural closeness of the predictive model in terms of learning data. An example of evaluating the structural closeness of the predictive model in terms of learning data is given below.

First, the predictive model evaluation unit 13 specifies in which of the components used in the pre-relearning predictive model a plurality of sample points in a learning interval are located, and generates a set of sample points for each component. The predictive model evaluation unit 13 then specifies in which of the components used in the relearned predictive model the same plurality of sample points are located, and generates a set of sample points for each component. The predictive model evaluation unit 13 calculates, for each set, the proportion in which the sample points in the same set before relearning are included in the set of sample points after relearning, and specifies the maximum proportion of the proportions. The predictive model evaluation unit 13 performs this process for all sets before relearning, and calculates the average of the maximum proportions.

A larger average of the maximum proportions means that the set of sample points classified in the component before relearning is classified in the component after relearning with less dispersion. The user can regard such a predictive model as structurally close because, for the data group for which the same prediction is performed before relearning, the same prediction is also performed after relearning. Thus, the predictive model evaluation unit 13 may evaluate the proportion of sample points commonly classified in the relearned predictive model to the set of sample points commonly classified in the pre-relearning predictive model, as the structural closeness of the predictive model.

In the case where the component (predictive formula) used for prediction of input data is split into cases according to the contents of the data, the predictive model evaluation unit 13 may evaluate the closeness in case splitting as the structural closeness of the predictive model. The case splitting process can be regarded as a process of splitting, for a predictive model (e.g. regression tree) with a mixture of components, each component. Hence, the structural closeness of the predictive model can be regarded as the closeness in component splitting.

The following describes the closeness in component splitting using an example that employs entropy. In the following description, the pre-relearning predictive model is also referred to as “old model”, the relearned predictive model as “new model”, and the component simply as “formula”. The number of the component (predictive formula) used in the old model is denoted by x, and the number of the component (predictive formula) used in the new model by y.

The degree of dispersion of a given sample in each formula of the predictive model is expressed by entropy. For example, entropy H(x) in the case where the old model is given is defined by the following Formula 1. In Formula 1, Pₓ is the probability of the sample being assigned to the xth formula of the old model.

$$\begin{matrix}[ Math . 1 ] & \\ H ( x ) = - {\sum }_{x} {P}_{x} {log}_{2} ( {P}_{x} ) & ( Formula 1 )\end{matrix}$$

The joint entropy H(x, y) in the case where the old model and the new model are given is defined by the following Formula 2. In Formula 2, P_{x,y} is the probability in which the xth formula in the old model corresponds to the yth formula in the new model, and is calculated based on the number of the substantially corresponding data set assigned to each formula of the new and old models. In other words, the calculated joint entropy is smaller when the bias of the assigned formula is smaller.

$$\begin{matrix}[ Math . 2 ] & \\ H ( x , y ) = - {\sum }_{x , y} {P}_{x , y} {log}_{2} ( {P}_{x , y} ) & ( Formula 2 )\end{matrix}$$

The predictive model evaluation unit 13 evaluates both models as being structurally close, when the index that indicates to what degree the component of the new model to which a sample is assigned is obvious as a result of the component of the old model to which the sample is assigned being obvious. This index is represented by mutual information, and the mutual information I(x;y) of the probability distribution mentioned above is defined by the following Formula 3.

[Math. 3]

I(x;y)=H(x)+H(y)−H(x,y) (Formula 3)

Thus, when samples assigned to a formula in the old model are assigned to a formula in the new model with a greater bias, both models are closer. When samples assigned to a formula in the old model are assigned to a formula in the new model more uniformly, both models are less close. The predictive model evaluation unit 13 may evaluate the closeness in property between both predictive models based on the degree of disorder between the component determined in the old model and the component determined in the new model in this way. The predictive models are determined to be less close when the degree of disorder is higher.

The above describes the case where the predictive model evaluation unit 13 performs evaluation by focusing on the change in property of the predictive model. The change of the predictive model to be focused is, however, not limited to the change in prediction result or the structural change of the predictive model. The predictive model evaluation unit 13 may, for example, evaluate the change in evaluation index such as the change in estimation accuracy or the change in the number of samples used in the predictive model, as the change in property of the predictive model.

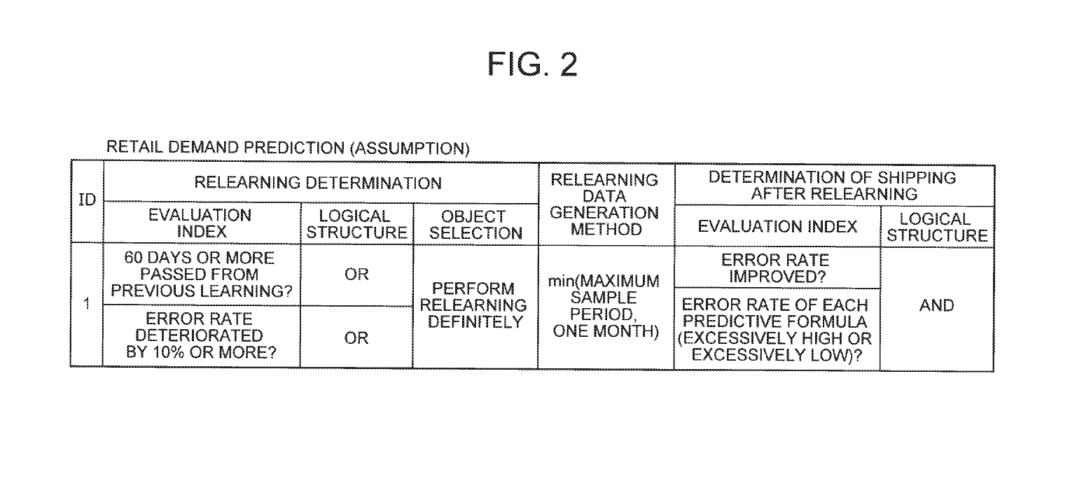

FIG. 2 is an explanatory diagram depicting an example of the evaluation index, the relearning rule, and the update evaluation rule. The field “relearning determination” depicted in FIG. 2 is a structural element defining the relearning rule, and indicates that the relearning rule is expressed as a condition obtained by joining the respective conditions of the evaluation indices in the column “evaluation index” by the operators in the field “logical structure”. The field “object selection” indicates a rule for selecting a relearning object from among the predictive models conforming to the relearning rule. The field “relearning data generation method” indicates a method of generating learning data used in relearning. The field “determination of shipping after relearning” is a structural element defining the update evaluation rule, and indicates that the update evaluation rule is expressed as a condition obtained by joining the respective conditions of the evaluation indices in the column “evaluation index” by the operators in the field “logical structure”.

Other than the evaluation index depicted in FIG. 2, for example, the average error rate difference between the most recent one week and one week immediately after learning, the error rate change for each predictive formula (after passing the gate function) in heterogeneous mixture learning, or the passage of time may be used as an evaluation index. The predictive model evaluation unit 13 may evaluate the value of the formula of logical joint (AND/OR) or linear joint on these evaluation indexes, and determine a predictive model meeting a predetermined condition as an update target.

The predictive model update determination unit 11 may equally evaluate the value of the formula of logical joint (AND/OR) or linear joint on these evaluation indexes and, further based on computational resources, extract a predetermined number of predictive models as relearning target predictive models.

Information that can be easily determined by humans are set in the evaluation indexes in FIG. 2. In other words, the rule combining the evaluation indexes in FIG. 2 by the logical structure is easily recognizable to humans, and is useful in update determination. The use of the evaluation indexes in FIG. 2 makes the relearning process and the updating process in whitebox form to facilitate understanding, so that personnel costs when examining rules can be reduced.

As depicted in FIG. 2, the criterion (relearning rule) used by the predictive model update determination unit 11 and the criterion (relearning rule) used by the predictive model evaluation unit 13 need not be the same. In this exemplary embodiment, two criterion stages are provided until a predictive model in operation is updated. With such two criterion stages, the predictive models to be processed can be narrowed to thus reduce the whole costs of the system.

The update evaluation rule is used to update a predictive model in operation. Accordingly, the update evaluation rule may be set as a stricter condition than the relearning rule. The object of determination (attribute, the number of days passed, etc.) used in the relearning rule and the update evaluation rule may be the same or different.

The predictive model updating unit 14 updates the pre-relearning predictive model with the relearned predictive model, in the case where the closeness in property between both predictive models evaluated by the predictive model evaluation unit 13 meets the condition prescribed by the update evaluation rule. The update evaluation rule prescribes the closeness that allows updating the predictive model, depending on the evaluation. The predictive model updating unit 14 may alert the user, instead of automatically updating the predictive model. Any alerting method may be used, such as display on a screen or notification by mail.

The result output unit 15 outputs the relearning result by the predictive model relearning unit 12 and/or the update result by the predictive model updating unit 14. The result output unit 15 may display the relearning result and/or the update result on a display device (not depicted).

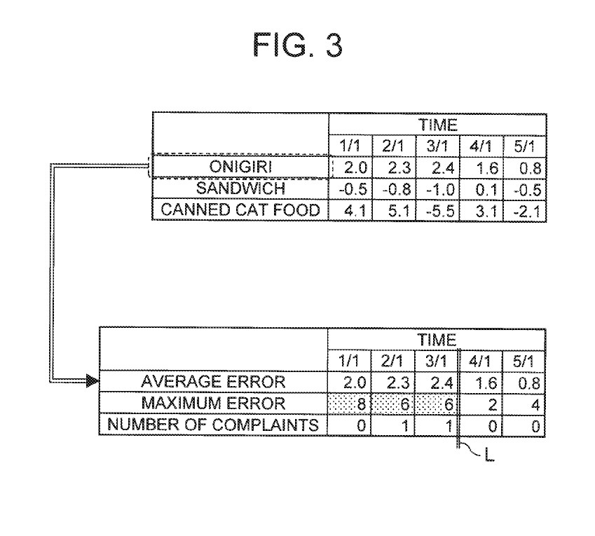

For example, the result output unit 15 may visualize the evaluation index of the predictive model conforming to the relearning rule in a manner distinguishable (e.g. highlighting) from other evaluation indexes. FIG. 3 is an explanatory diagram depicting an example of visualizing the predictive model accuracy index. FIG. 3 depicts monthly evaluation indexes for three types of prediction targets (onigiri, sandwich, canned cat food). In the example in FIG. 3, relearning is performed in the case where the predictive model meets the relearning rule “the maximum error absolute value is more than 5 for three consecutive months”.

In the example in FIG. 3, the result output unit 15 first outputs the monthly average error for each of the three types of prediction targets. When one prediction target (onigiri in this example) is selected in this state, the result output unit 15 outputs a table for the selected prediction target including other evaluation indexes (maximum error, the number of complaints in this example).

The result output unit 15 further visualizes the part causing relearning, in a manner distinguishable from other indexes. In the example in FIG. 3, the maximum error absolute value from January to March is more than 5, which results in relearning the predictive model. The result output unit 15 accordingly displays the field of the maximum error absolute value from January to March by hatching (highlighting). The result output unit 15 may visualize the update timing (line L in FIG. 3).

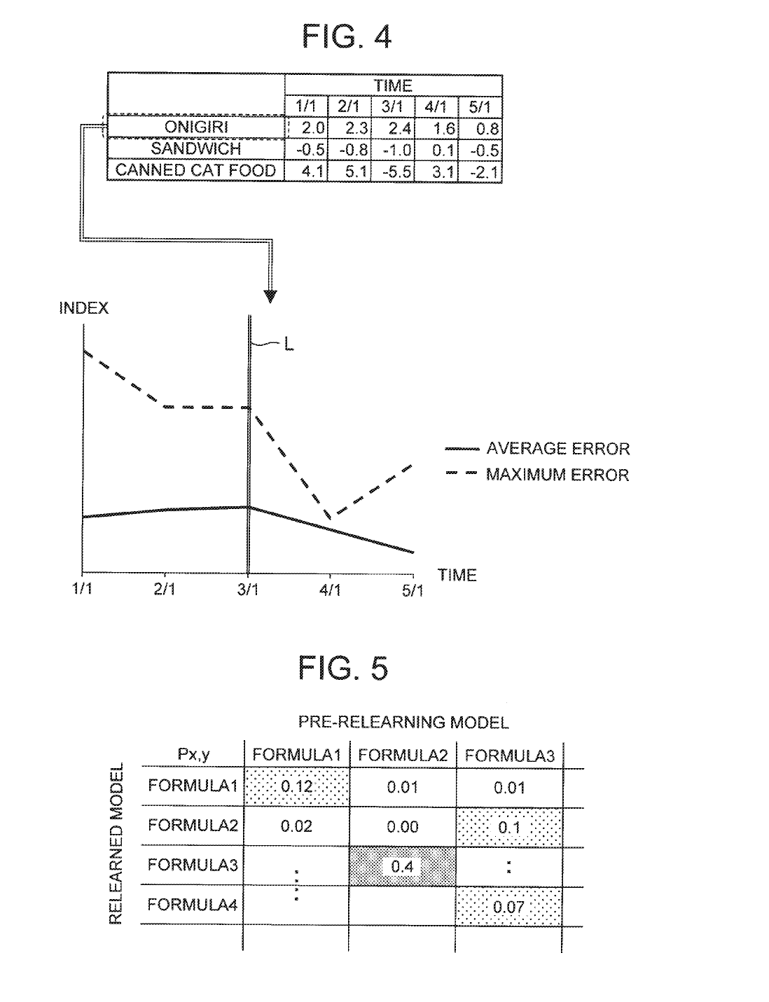

FIG. 4 is an explanatory diagram depicting another example of visualizing the predictive model accuracy index. In the example in FIG. 4, the evaluation indexes of the prediction targets are output in graph form, which corresponds to the other evaluation indexes output in table form in FIG. 3. The result output unit 15 highlights the line graph indicating the maximum error absolute value from January to March. The result output unit 15 may visualize the update timing (line L in FIG. 4), as in FIG. 3.

The result output unit 15 may visualize the similarity in property between the pre-relearning predictive model and the relearned predictive model, as the relearning result by the predictive model relearning unit 12. FIG. 5 is an explanatory diagram depicting an example of visualizing the similarity between the pre-relearning predictive model and the relearned predictive model. The example in FIG. 5 indicates in what proportion validation data assigned to each formula in the pre-relearning predictive model is assigned to the formula in the relearned predictive model, which corresponds to the aforementioned P_{x,y}. The result output unit 15 may output the table depicted in FIG. 5, and output the data in heat map depending on the value of the proportion as depicted in FIG. 5.

By visualizing and outputting the relearning result and/or the update result by the result output unit 15 in this way, the reason for update or the update timing is easily recognizable to humans, as a result of which personnel costs can be reduced.

The predictive model update determination unit 11, the predictive model relearning unit 12, the predictive model evaluation unit 13, the predictive model updating unit 14, and the result output unit 15 are realized by a CPU in a computer operating according to a program (predictive model updating program). For example, the program may be stored in the storage unit 11, with the CPU reading the program and, according to the program, operating as the predictive model update determination unit 11, the predictive model relearning unit 12, the predictive model evaluation unit 13, the predictive model updating unit 14, and the result output unit 15.

Alternatively, the predictive model update determination unit 11, the predictive model relearning unit 12, the predictive model evaluation unit 13, the predictive model updating unit 14, and the result output unit 15 may each be realized by dedicated hardware. The predictive model updating system according to the present invention may be composed of two or more physically separate apparatuses that are wiredly or wirelessly connected to each other.

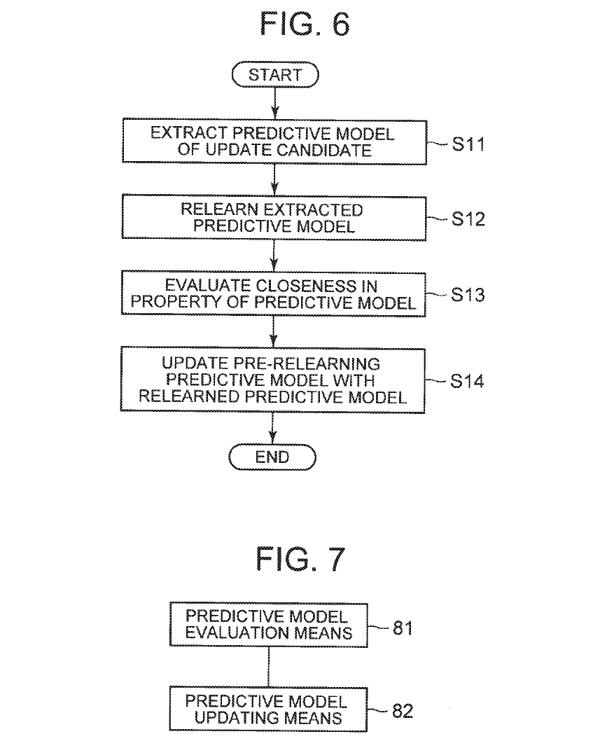

The following describes the operation of the predictive model updating system in this exemplary embodiment. FIG. 6 is a flowchart depicting an example of the operation of the predictive model updating system in this exemplary embodiment. First, the predictive model update determination unit 11 extracts a predictive model of an update candidate from the plurality of predictive models based on the relearning rule (step S11). The predictive model relearning unit 12 relearns the extracted predictive model (step S12).

The predictive model evaluation unit 13 evaluates the closeness in property between the relearned predictive model and the pre-relearning predictive model, based on the update evaluation rule (step S13). In the case where the evaluated closeness in property meets the closeness prescribed by the update evaluation rule, the predictive model updating unit 14 updates the pre-relearning predictive model with the relearned predictive model (step S14).

As described above, in this exemplary embodiment, the predictive model evaluation unit 13 evaluates the closeness in property between the relearned predictive model and the pre-relearning predictive model. In the case where the evaluated closeness in property meets the closeness prescribed by the update evaluation rule, the predictive model updating unit 14 updates the pre-relearning predictive model with the relearned predictive model. In detail, the predictive model evaluation unit 13 evaluates the closeness in prediction result or the structural closeness as the closeness in property of the predictive model. This reduces personnel costs when updating the predictive model.

Typically, in operation using a predictive model with interpretiveness, the user recognizes the property (e.g. less predictable situation, predictive model use method, etc.) of the predictive model, and optimizes the operation. Accordingly, with a method of evaluating a predictive model only by a property index and updating the model, there is a possibility that the structure of the predictive model itself changes greatly. In such a case, the property of the predictive model changes greatly, too, so that the user needs to recognize the property of the predictive model again and review the operation method. This requires considerable personnel costs.

In this exemplary embodiment, on the other hand, the predictive model evaluation unit 13 evaluates the closeness in property between the relearned predictive model and the pre-relearning predictive model. In the case where the evaluated closeness in property meets a predetermined condition, the predictive model updating unit 14 updates the predictive model. The predictive model updated in this way is approximate in property to the predictive model before the update. Since the change in property of the predictive model is reduced, the user is likely to be able to perform the operation efficiently. Personnel costs associated with updating the predictive model can thus be reduced.

This exemplary embodiment describes an example where the predictive model updating system includes the predictive model update determination unit 11, the predictive model relearning unit 12, the predictive model evaluation unit 13, the predictive model updating unit 14, and the result output unit 15.

In the case where the result output unit 15 visualizes and outputs at least one of the relearning result and the update result, another system may be realized by part of the structure of the predictive model updating system. As an example, a relearning result visualization system for visualizing the relearning result may be realized by a structure including the predictive model update determination unit 11, the predictive model relearning unit 12, and the result output unit 15. As another example, an update result visualization system for visualizing the update result may be realized by a structure including the predictive model evaluation unit 13, the predictive model updating unit 14, and the result output unit 15.

The following describes an overview of the present invention. FIG. 7 is a block diagram schematically depicting a predictive model updating system according to the present invention. The predictive model updating system according to the present invention includes: predictive model evaluation means 81 (e.g. the predictive model evaluation unit 13) which evaluates closeness in property between a relearned predictive model and a pre-relearning predictive model; and predictive model updating means 82 (e.g. the predictive model updating unit 14) which updates the pre-relearning predictive model with the relearned predictive model, in the case where the closeness in property meets closeness prescribed by a predetermined condition (e.g. update evaluation rule).

The predictive model evaluation means 81 evaluates closeness in prediction result or structural closeness, as the closeness in property of the predictive model. With such a structure, personnel costs when updating a predictive model can be reduced.

The predictive model updating system may include: predictive model extraction means (e.g. the predictive model update determination unit 11) which extracts a predictive model meeting a condition prescribed by a rule (e.g. relearning rule) for determining whether or not to relearn the predictive model, from among a plurality of predictive models; and predictive model relearning means (e.g. the predictive model relearning unit 12) which relearns the extracted predictive model. The predictive model evaluation means 81 may evaluate the closeness in property between the relearned predictive model obtained by the predictive model relearning means and the pre-relearning predictive model.

With such a structure, the relearning target predictive models can be narrowed, so that computational costs (e.g. machine resources) can be reduced. This is more effective in the case where there are a larger number of predictive models as targets.

The pre-relearning predictive model and the relearned predictive model may be a predictive model (e.g. a tree structure predictive model, a predictive model generated by a heterogeneous mixture learning algorithm, etc.) whose component used for prediction of a sample of a prediction target is determined according to contents of the sample. The predictive model evaluation means 81 may evaluate the closeness in property of the predictive model, based on a degree of disorder (e.g. entropy, mutual information) between the component determined in the pre-relearning predictive model and the component determined in the relearned predictive model for the sample of the prediction target.

The predictive model evaluation means 81 may evaluate closeness between a prediction result by the pre-relearning predictive model and a prediction result by the relearned predictive model, as the closeness in property (e.g. closeness in prediction result) of the predictive model.

The predictive model evaluation means 81 may evaluate a degree of overlap between an attribute (e.g. explanatory variable) used in the pre-relearning predictive model and an attribute used in the relearned predictive model, as the closeness in property (e.g. structural closeness) of the predictive model.

The predictive model evaluation means 81 may evaluate a proportion of sample points commonly classified in the relearned predictive model to a set of sample points commonly classified in the pre-relearning predictive model, as the closeness in property (e.g. structural closeness) of the predictive model.

### REFERENCE SIGNS LIST

11 predictive model update determination unit
12 predictive model relearning unit
13 predictive model evaluation unit
14 predictive model updating unit
15 result output unit

1. A predictive model updating system comprising:
hardware including a processor;
a predictive model evaluation unit implemented at least by the hardware and which evaluates closeness in property between a relearned predictive model and a pre-relearning predictive model; and
a predictive model updating unit implemented at least by the hardware and which updates the pre-relearning predictive model with the relearned predictive model, in the case where the closeness in property meets closeness prescribed by a predetermined condition,
wherein the predictive model evaluation unit evaluates closeness in structure of the relearned predictive model and structure of the pre-relearning predictive model, as the closeness in property of the predictive model.

2. The predictive model updating system according to claim 1, comprising:
a predictive model extraction unit implemented at least by the hardware and which extracts a predictive model meeting a condition prescribed by a rule for determining whether or not to relearn the predictive model, from among a plurality of predictive models; and
a predictive model relearning unit implemented at least by the hardware and which relearns the extracted predictive model,
wherein the predictive model evaluation unit evaluates the closeness in property between the relearned predictive model obtained by the predictive model relearning unit and the pre-relearning predictive model.

3. The predictive model updating system according to claim 1, wherein the pre-relearning predictive model and the relearned predictive model are a predictive model whose component used for prediction of a sample of a prediction target is determined according to contents of the sample, and
wherein the predictive model evaluation unit evaluates the closeness in property of the predictive model, based on a degree of disorder between the component determined in the pre-relearning predictive model and the component determined in the relearned predictive model for the sample of the prediction target.

4. (canceled)

5. The predictive model updating system according to claim 1, wherein the predictive model evaluation unit evaluates a degree of overlap between an attribute used in the pre-relearning predictive model and an attribute used in the relearned predictive model, as the closeness in property of the predictive model.

6. The predictive model updating system according to claim 1, wherein the predictive model evaluation unit evaluates a proportion of sample points commonly classified in the relearned predictive model to a set of sample points commonly classified in the pre-relearning predictive model, as the closeness in property of the predictive model.

7. A predictive model updating method performed by a computer, comprising:
evaluating closeness in property between a relearned predictive model and a pre-relearning predictive model; and
updating the pre-relearning predictive model with the relearned predictive model, in the case where the closeness in property meets closeness prescribed by a predetermined condition,
wherein in the evaluation of the closeness in property, the computer evaluates closeness in structure of the relearned predictive model and structure of the pre-relearning predictive model, as the closeness in property of the predictive model.

8. The predictive model updating method according to claim 7, comprising:
extracting a predictive model meeting a condition prescribed by a rule for determining whether or not to relearn the predictive model, from among a plurality of predictive models; and
relearning the extracted predictive model,
wherein in the evaluation of the closeness in property, the computer evaluates the closeness in property between the relearned predictive model obtained and the pre-relearning predictive model.

9. A non-transitory computer readable information recording medium storing a predictive model updating program, when executed by a processor, that performs a method for:
evaluating closeness in property between a relearned predictive model and a pre-relearning predictive model; and
updating the pre-relearning predictive model with the relearned predictive model, in the case where the closeness in property meets closeness prescribed by a predetermined condition,
wherein in the evaluation of the closeness in property, evaluating closeness in structure of the relearned predictive model and structure of the pre-relearning predictive model, as the closeness in property of the predictive model.

10. The non-transitory computer-readable recording medium according to claim 9, comprising:
extracting a predictive model meeting a condition prescribed by a rule for determining whether or not to relearn the predictive model, from among a plurality of predictive models; and
relearning the extracted predictive model,
wherein in the evaluation of the closeness in property, evaluating the closeness in property between the relearned predictive model obtained and the pre-relearning predictive model.

11. A predictive model updating system comprising:
hardware including a processor;
a predictive model evaluation unit implemented at least by the hardware and which evaluates closeness in property between a relearned predictive model and a pre-relearning predictive model; and
a predictive model updating unit implemented at least by the hardware and which updates the pre-relearning predictive model with the relearned predictive model, in the case where the closeness in property meets closeness prescribed by a predetermined condition,
wherein the predictive model evaluation unit evaluates closeness in prediction result of the relearned predictive model and prediction result of the pre-relearning predictive model, as the closeness in property of the predictive model.

12. The predictive model updating system according to claim 11,
a predictive model extraction unit implemented at least by the hardware and which extracts a predictive model meeting a condition prescribed by a rule for determining whether or not to relearn the predictive model, from among a plurality of predictive models; and
a predictive model relearning unit implemented at least by the hardware and which relearns the extracted predictive model,
wherein the predictive model evaluation unit evaluates the closeness in property between the relearned predictive model obtained by the predictive model relearning unit and the pre-relearning predictive model.

13. The predictive model updating system according to claim 11, wherein the pre-relearning predictive model and the relearned predictive model are a predictive model whose component used for prediction of a sample of a prediction target is determined according to contents of the sample, and
wherein the predictive model evaluation unit evaluates the closeness in property of the predictive model, based on a degree of disorder between the component determined in the pre-relearning predictive model and the component determined in the relearned predictive model for the sample of the prediction target.

14. A predictive model updating method performed by a computer, comprising:
evaluating closeness in property between a relearned predictive model and a pre-relearning predictive model; and
updating the pre-relearning predictive model with the relearned predictive model, in the case where the closeness in property meets closeness prescribed by a predetermined condition,
wherein in the evaluation of the closeness in property, the computer evaluates closeness in prediction result of the relearned predictive model and prediction result of the pre-relearning predictive model, as the closeness in property of the predictive model.

15. A non-transitory computer readable information recording medium storing a predictive model updating program, when executed by a processor, that performs a method for:
evaluating closeness in property between a relearned predictive model and a pre-relearning predictive model; and
updating the pre-relearning predictive model with the relearned predictive model, in the case where the closeness in property meets closeness prescribed by a predetermined condition,
wherein in the evaluation of the closeness in property, evaluating closeness in prediction result of the relearned predictive model and prediction result of the pre-relearning predictive model, as the closeness in property of the predictive model.
